(19) United States
(12) Patent Application Publication
(10) Pub. No.: US 2003/0099903 A1
(43) Pub. Date: May 29, 2003

(54) Rewritable optical information recording medium

(76) Inventors: Ju Ming Liang, Hsinchu (TW); Xiao Min Song, Hsinchu (TW); Jin Zhang Lin, Hsinchu (TW); Tong Luo, Hsinchu (TW)

Correspondence Address: Eugene Mar, BACON & THOMAS, PLLC, Fourth Floor, 625 Slaters Lane, Alexandria, VA, 22314-1176, US

(21) Appl. No.: 09/994,709

(22) Filed: Nov. 28, 2001

(51) Int. Cl. G11B 7/24

(52) U.S. Cl. 430/270.13; 430/945; 428/64.5; 369/275.2; 369/275.5

(57) ABSTRACT

This invention relates to a rewritable optical information recording medium essentially comprising a substrate and a recording layer formed on said substrate, wherein the recording layer has the following composition:

AₐB_{b}C_{c}In_{d}Mₑ

wherein A is gold or silver; B is Sb or Bi; C is Te or Se; M is an element selected from the group consisting of Ti, Zr, Hf, V, Nb, Ta, Mg, W, Mo, B, C, N, P and Si; 0<a<13.0; 10<b<87.0; 8.0<c<50; 0<d<30.0; 0<e<8; and a+b+c+d+e=100 atom %. The recording layer is located between upper and lower dielectric layers and a reflective layer is located on said upper dielectric layer, wherein the reflective layer, which has a thickness of at least 1500 Å, can reflect laser radiation signals to the recording layer.

### FIELD OF THE INVENTION

The invention relates to a rewritable optical information recording medium and, more particularly, to a rewritable optical information recording medium which has high modulation and high rewritability.

### BACKGROUND OF THE INVENTION

Since the enter of information and technology era, the need of the information recording medium is increased rapidly, especially for the rewritable optical information recording medium. U.S. Pat. No. 5,298,305 discloses a phase-change type information recording medium, which mainly comprises a recording layer with the composition of the following formula:

Ag_{α}In_{β}Te_{γ}Sb_{δ}+Mₓ

wherein 5≦α≦17, 6≦β≦18, 13≦γ≦36, 33≦δ≦77, 0.5≦×≦10, α+β+γ+δ+×=100 atom %, and M is an additional element selected from the group consisting of B, N, C, P and Si. With the above composition of the recording material of said US patent, the C/N ratio of the recording medium and the erasability in the overwriting operation can be improved. In addition, with the additional element M, the overwriting repetition properties has been changed for more than 10⁵ revolutions (the testing method is different from the commercial compact disc testing method). However, adding the element M during the process will increase the trouble and the inconvenience in the manufacturing process of the recording media, and also will cause the phase separation of recording layer. Due to the above-mentioned defects, the inventors of the present invention have focused their attention to a rewritable optical information recording medium with improvements in the layer thickness.

### DETAILED DESCRIPTION OF THE INVENTION

Therefore, the main objective of the present invention is to provide a rewritable optical information recording medium with high modulation.

The other objective of the present invention is to provide a rewritable optical information recording medium with high rewritability.

To achieve the above-mentioned objectives, the rewritable optical information recording medium according to the present invention essentially comprises, from bottom to top, a substrate, lower dielectric layers laminated on said substrate, a recording layer, a first upper dielectric layer, a second upper dielectric layer and a reflective layer, wherein the recording layer comprises the following composition:

AₐB_{b}C_{c}In_{d}Mₑ

wherein A is gold or silver, B is Sb or Bi, C is Te or Se, and M is an element selected from the group consisting of Ti, Zr, Hf, V, Nb, Ta, Mg, W, Mo, B, N, C, P and Si; 0<a<13.0, 10<b<87.0, 8.0<c<50, 0<d<30.0, 0<e<8, a+b+c+d+e=100 atom %; and the thickness of the reflective layer is larger than 1500 Å.

The present invention is now described in detail with reference to the preferred embodiments and drawings as below:

### BRIEF DESCRIPTION OF THE DRAWINGS

FIG. 1 is a cross sectional view of a rewritable optical information recording medium according to the present invention;

FIG. 2 is an I₁₁/Iₜₒₚ property coordinates diagram of each stage for the re-writing test of each sample;

FIG. 3 is a Rₜₒₚ property coordinates diagram of each stage for the re-writing test of each sample;

FIG. 4 is a Block Error Rate (BER) property coordinates diagram of each stage for the re-writing test of each sample; and

FIG. 5 is a Jitter-3T property coordinates diagram of each stage for the re-writing test of each sample.

### DESCRIPTION OF THE PREFERRED EMBODIMENTS

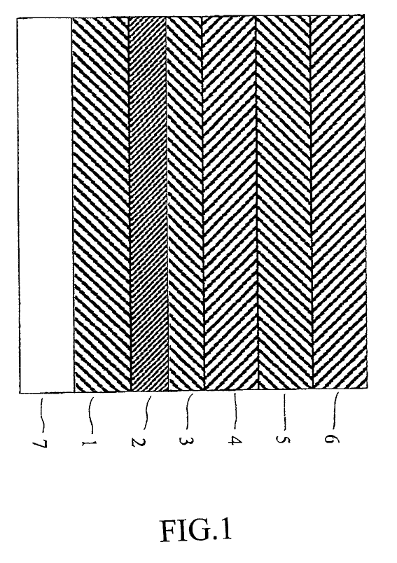

Referring to FIG. 1, the rewritable optical information recording medium according to the present invention comprises a substrate 7, a lower dielectric layer 1, a recording layer 2, a first upper dielectric layer 3, a second upper dielectric layer 4, a reflective layer 5, and a protective layer 6, which are successively laminated on the substrate 7. It should be noted that the structure of the recording media according to the present invention is not limited to the layout as described above and any conversion with equivalent effects is within the scope of the present invention.

Any material with excellent transparency as well as high heat-resistance, weather-resistance and chemical-resistance is suitable for use as the substrate 7 of the present invention. Preferred examples include glass plate, plastic material film (such as polycarbonate and amorphous polyolefins). A guide groove and pits can be easily formed on the material described above by 2P (photo-polymerization) methods or by injection molding methods. When a glass plate is used as a substrate, the guide groove and pits can be formed thereon by dry etching according to close contact exposure methods.

The recording layer 2 comprises following composition (expressed by atom percentage):

AₐB_{b}C_{c}In_{d}Mₑ

wherein A is gold or silver, B is Sb or Bi, C is Te or Se, and M is an element selected from the group consisting of Ti, Zr, Hf, V, Nb, Ta, Mg, W, Mo, B, C, N, P and Si; 0<a<13.0; 10<b<87.0; 8.0<c<50; 0<d<30.0; 0<e<8; and a+b+c+d+e=100 atom %.

For use as the recording layer 2, the element A contains at least 50 atom % (preferably at least 80 atom %) of silver, the element B contains at least 50 atom % (preferably at least 80 atom %) of Sb and the element C contains at least 50 atom % (preferably at least 80 atom %) of Te. The thickness of the recording layer 2 is between 50 and 600 Å, preferably between 130 and 300 Å.

The lower dielectric layer 1 is mainly used to protect and prevent the recording layer 2 from oxidation by the moisture in atmosphere. Thus, the suitable materials are selected from the group consisting of SiN, AlN, Ta₂O₅, ZnS, SiO₂ and Al₂O₃. The preferred example is a composite material of ZnS/SiO₂, wherein the molar ratio of ZnS is 70-90%. The thickness of said lower dielectric layer 1 is between 600 and 2000 Å.

The materials may be used as the first upper dielectric layer 3 is AlN, SiN, or Al₂O₃. The thermal conductivity of the second upper dielectric layer 4 must be lower than the first upper dielectric layer 3. The material suitable for the second upper dielectric layer is ZnS/SiO₂. The thickness of the first upper dielectric layer 3 and the second upper dielectric layer 4 both are between 50 and 500 Å. Additionally, the first upper dielectric layer 3 and the second upper dielectric layer 4 may be in the same material and thus combined as one layer. In this case, the combined layer preferably has a thickness of 50 to 1000 Å.

The reflective layer 5 not only has a function of reflecting the laser radiation signals, but also is heat conductive. Due to the heat conductivity, the reflective layer 5 can avoid the heat retention on the dielectric layers 3 and 4. As a result, when information is recorded to the recording layer 2 by a phase-change method, the heat energy can be controlled effectively to shorten the length deviation of the recording signals (due to lack of the heat diffusion effect), which also makes the recording signals clear. In view of the above, as compared with the upper dielectric layers 3 and 4, the reflective layer 5 must has a better heat conductivity. The materials suitable for such purposes include gold, silver, copper, aluminum or the alloys thereof. Such reflective layer 5 can be formed on the second upper dielectric layer 4 by known sputtering methods to have a thickness of 300 to 6000 Å, preferably from 1500 to 4000 Å.

The protective layer 6 is provided to prevent the laminated layers from being oxidized and scratched. The materials suitable therefor include UV-curable resin, thermoplastic resins, etc. It is preferred that the protective layer 6 has a thickness of 1 to 10 m.

### EXAMPLE 1

A round polycarbonate resin substrate having a continuous spiral groove (50 nm deep and 450 nm wide, the pitch therebetween being 1600 nm) and a thickness of 1.18 mm, an outer diameter of 120 mm and an inner diameter of 15 mm is produced by means of an injection molding machine. The film layers as shown in FIG. 1 are formed on the surface of the substrate by sputtering, wherein the lower dielectric layer 1 uses ZnS—SiO₂ (80:20 mol %) as a target material and is sputtered on the substrate 7. The recording layer 2 is sputtered by using with Ag₅In₅Te₆₀Sb₃₀ as the target material, and the composition of the sputtered recording layer is analyzed by ICP as: Ag_{5.01}In_{4.91}Te₆₀Sb_{29.98} (alloy composition is expressed by atom %). The first upper dielectric layer 3 and the second upper dielectric layer 4 are sputtered with the same target material (that is, ZnS—SiO₂) as the lower dielectric layer 1. The reflective layer 5 is sequentially sputtered on substrate 7 with Al—Ti alloy (in which the content of Ti is 1.5 atom %), and has a thickness of 3500 Å, while the protective layer 6 is formed by coating ultraviolet ray curable resin on the substrate 7 with spin-on coating method, then irradiating the resin with ultraviolet ray to form a film having a thickness of 1 to 10 m. After the sputtering and coating for all the layers above are completed, the resultant disk is initialized with the initialization machine to crystallize the recording layer. The disk obtained from the above process is labeled as sample 1.

### EXAMPLE 2

The thickness of the reflective layer 5 is changed to 3000 Å, the other processes are the same as in Example 1, and the obtained disk is labeled as sample 2.

### EXAMPLE 3

The thickness of the reflective layer 5 is changed to 2500 Å, the other processes are the same as in Example 1, and the obtained disk is labeled as sample 3.

### EXAMPLE 4

The thickness of the reflective layer 5 is changed to 2000 Å, the other processes are the same as in Example 1, and the obtained disk is labeled as sample 4.

### EXAMPLE 5

The thickness of the reflective layer 5 is changed to 1500 Å, the other processes are the same as in Example 1, and the obtained disk is labeled as sample 5.

### EXAMPLE 6

The thickness of the reflective layer 5 is changed to 1000 Å, the other processes are the same as in Example 1, and the obtained disk is labeled as sample 6.

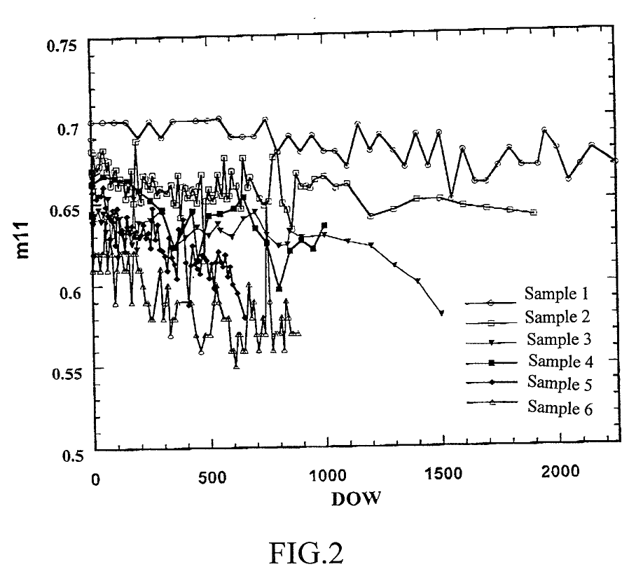

The samples obtained from example 1 to example 6 are put into Yamaha 4416 CD-RW writer respectively, written repeatedly with four times speed to the same focus area, and tested by the four times disk drive for every 50 times of re-writing. The results are the illustrated diagrams of FIG. 2 to FIG. 5.

According to the results shown in FIG. 2, the thicker the reflective layer 5 is, the higher the modulation is, and the modulation will not change significantly after multiple re-writting.

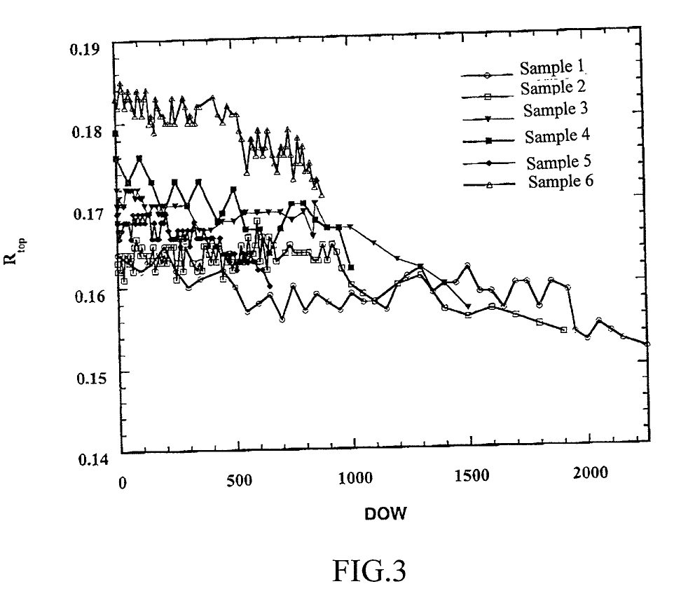

According to the results shown in FIG. 3, the thicker the reflective layer 5 is, the lower the reflectance (Rₜₒₚ) is.

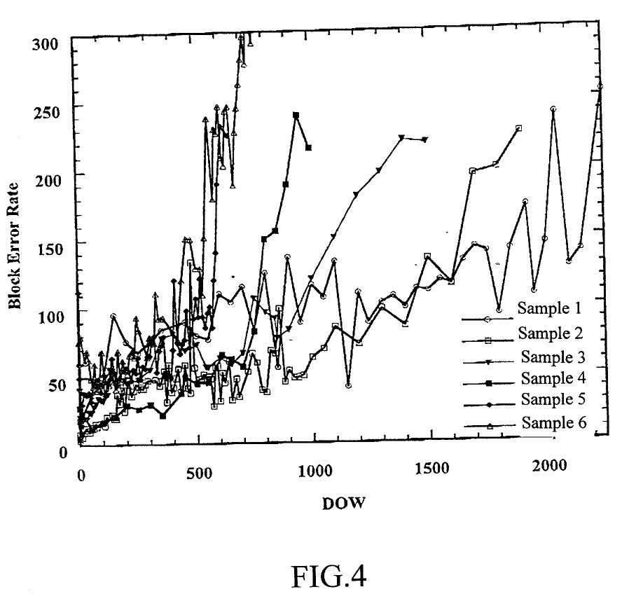

Moreover, according to the results as shown in FIG. 4, the thicker the reflective layer 5 is, the better the rewritablity is, wherein after re-written 2250 times, sample 1 (3500 Å thick) still has a block error rate not exceeding the standard value of 220.

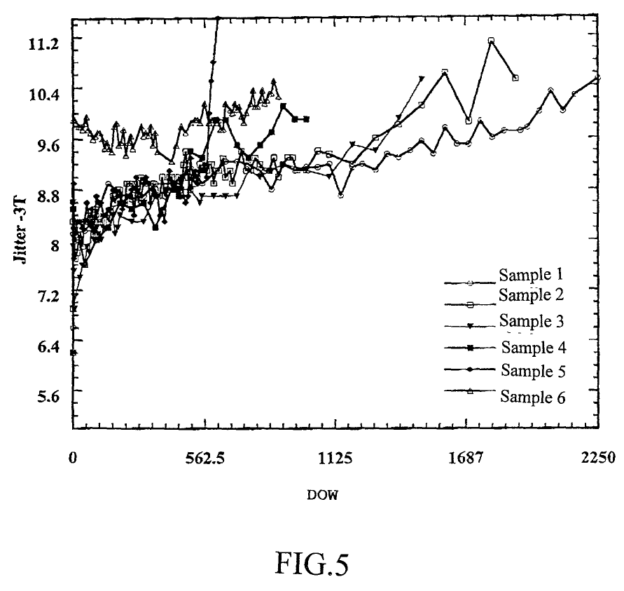

Moreover, according to the results of FIG. 5, the thicker the reflective layer 5 is, the smaller the initial jitter is.

Through the results described above, with the disclosed technique, the present invention indeed can achieve the objects of high modulation and high rewritability.

We claim:

1. A rewritable optical information recording medium comprising:
a substrate;
a recording layer, which is formed on said substrate and has the following composition:
AₐB_{b}C_{c}In_{d}Mₑ
wherein A is gold or silver; B is Sb or Bi; C is Te or Se; M is an element selected from the group consisting of Ti, Zr, Hf, V, Nb, Ta, Mg, W, Mo, B, N, C, P and Si; 0<a<13.0; 10<b<87.0; 8.0<c<50; 0<d<30.0; 0<e<8; and a+b+c+d+e=100 atom %; and
a reflective layer, which is laminated on said recording layer and has a thickness of 1500 Å to 4000 Å.

2. The rewritable optical information recording medium according to claim 1, wherein the reflective layer is made from a material selected from the group consisting of gold, silver, copper, aluminum and alloys thereof.

3. The rewritable optical information recording medium according to claim 1 further comprising upper and lower dielectric layers located between the reflective layer and the recording layer.

4. The rewritable optical information recording medium according to claim 3, wherein the upper and lower dielectric layers are made from a material of ZnS—SiO₂ with ZnS in an amount of 70-90 mole %.

5. The rewritable optical information recording medium according to claim 3, wherein the upper and lower dielectric layers are made from a material selected from the group consisting of SiN, AlN, Ta₂O₅, ZnS, SiO₂, and Al₂O₃.

6. The rewritable optical information recording medium according to claim 1 further comprising a protective layer located on the recording layer.

7. The rewritable optical information recording medium according to claim 6, wherein the protective layer is made from a UV-curable resin.

8. The rewritable optical information recording medium according to claim 1, wherein the recording layer has a thickness of 50 Å to 600 Å.

9. The rewritable optical information recording medium according to claim 1, wherein the recording layer, the upper dielectric layer, the lower dielectric layer, and the reflective layer are laminated on the substrate by sputtering methods.
